(19) United States
(12) Patent Application Publication
(10) Pub. No.: US 2019/0295064 A1
(43) Pub. Date: Sep. 26, 2019

(54) METHOD AND SYSTEM FOR ASSISTING A PURCHASING TRANSACTION WITH MOBILE DEVICE

(71) Applicant: FEDERATION DES CAISSES DESJARDINS DU QUEBEC, Levis (CA)

(72) Inventor: Jean-Pierre MALO, Saint-Raymond (CA)

(21) Appl. No.: 16/360,421

(22) Filed: Mar. 21, 2019

Related U.S. Application Data
(60) Provisional application No. 62/646,025, filed on Mar. 21, 2018.

(51) Int. Cl. G06Q 20/32

(52) U.S. Cl. CPC G06Q 20/3226; G06Q 20/3221; G06Q 20/3224

(57) ABSTRACT

A method for assisting a purchase of an item with a mobile device, may comprise different steps: capturing, by the mobile device, a label image of an item, sending an identification associated with a user stored in the mobile device to a server system at least with the label image, receiving, by the mobile device and from the server system, and displaying terms of a financing option specific to the user as a function of a price on the label image, along with an indication of an action to perform to finance a purchase of the item according to the terms of the financing option, as an automatic response to the sending of the identification, and sending to the server system a request for financing along with the identification in response to the action being performed.

### CROSS-REFERENCE TO RELATED APPLICATION

The present application claims the priority of U.S. Patent Application Ser. No. 62/646,025, filed on Mar. 21, 2018 and incorporated herein by reference.

### TECHNICAL FIELD

The present application relates to on-site purchasing with the assistance of mobile devices.

### BACKGROUND OF THE ART

The evolution of telecommunications has had a transformational impact on electronic transactions. Digital wallets and digital payment solutions, for example, have become a common occurrence and have gained important market shares over traditional payment methods. Accordingly, numerous applications and electronic devices have been developed to allow smart device users to settle purchases. However, there are numerous functions enabled by telecommunications and smart device computing that remain unexplored.

### SUMMARY

It is therefore an aim of the present disclosure to provide a novel method for purchasing an item with a mobile device.

It is a further aim of the present disclosure to provide a novel system for purchasing an item with a mobile device.

Therefore, in accordance with an embodiment of the present disclosure, there is provided a method for assisting a purchase of an item with a mobile device, the method comprising: capturing, by the mobile device, a label image of an item, sending an identification associated with a user stored in the mobile device to a server system at least with the label image, receiving, by the mobile device and from the server system, and displaying terms of a financing option specific to the user as a function of a price on the label image, along with an indication of an action to perform to finance a purchase of the item according to the terms of the financing option, as an automatic response to the sending of the identification, and sending to the server system a request for financing along with the identification in response to the action being performed.

In accordance with a further embodiment of the present disclosure, there is provided a method for assisting a purchase of an item by a server system based on a request, the method comprising: receiving at least an identification associated to a user and a label image of an item from the mobile device, automatically obtaining or determining a price of the item from the label image, obtaining a balance of at least one account of the user associated to identification, determining terms of a financing option related to the price of the item, specifically for the user, automatically sending to the mobile device the terms of the financing option, for display, receiving a request for financing along with the identification in response to an action being performed at the mobile device, and implementing a transaction with the financing option according to said terms.

### DESCRIPTION OF THE DRAWINGS

FIG. 1 is a block diagram of a system for assisting a purchasing transaction using a non web-based application of a mobile device, in accordance with the present disclosure;

FIGS. 2A-2B are flowcharts concurrently illustrating a method for assisting a purchasing transaction, as performed by a non web-based application of a mobile device;

FIGS. 3A-3B are flowcharts concurrently illustrating a method for assisting a purchasing transaction based on a request from a non web-based application of a mobile device; and

FIG. 4 is a screen view of an exemplary mobile device scanner screen for the method of FIGS. 2A-2B;

FIG. 5 is a screen view of an exemplary mobile device screen with purchasing data and options for the method of FIGS. 2A-2B;

FIG. 6 is a screen view of an exemplary mobile device transaction code screen for the method of FIGS. 2A-2B;

FIG. 7 is a screen view of an exemplary mobile device project creation screen for the method of FIGS. 2A-2B;

FIG. 8 is a block diagram of a method for recognizing a price as part of the method for assisting a purchasing transaction based on a request from a non web-based application of a mobile device; and

FIG. 9 is a screen view of an exemplary chat screen of the mobile device with additional purchasing data and options related to the method of FIGS. 2A-2B.

### DETAILED DESCRIPTION

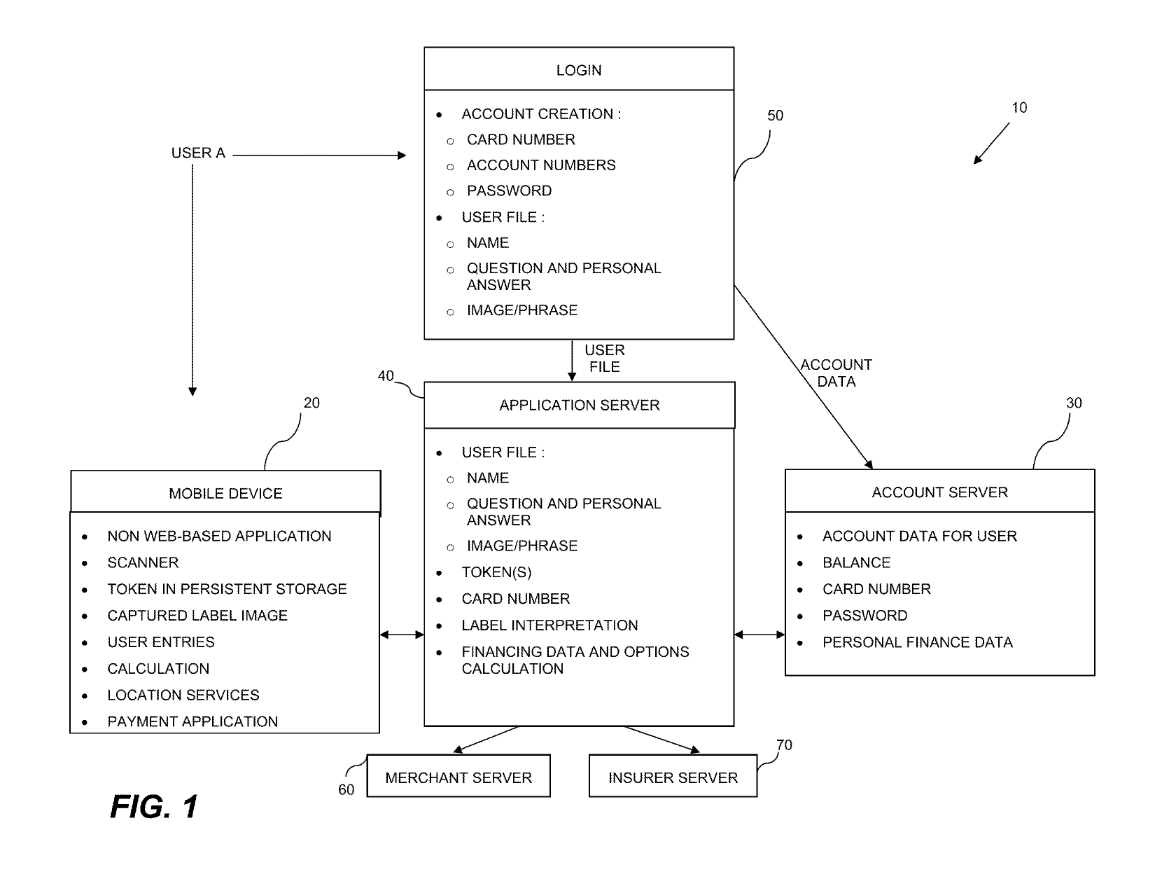

Referring to the drawings, and more particularly to FIG. 1, a system for assisting purchasing transactions using a mobile device is generally shown at 10. The system 10 involves a user A that performs such purchasing transactions with his/her mobile device 20. The user A may be known as a purchaser, customer, client, etc, whereas the purchasing transaction may also be known as a sale, a buy, a purchase, a settlement, a license, etc. The mobile device 20 is typically a cellular phone (a.k.a., a mobile phone, a smartphone, etc) that incorporates a non web-based application allowing such transactions. Hence, other mobile devices, including for instance tablets, watches, PDAs, having telecommunications capability for instance using Wi-Fi additionally or alternatively to the cellular network, may also qualify as mobile device 20.

With the mobile device 20, the user A accesses bank server systems to obtaining personal finance data. By way of the application, the mobile device 20 may perform or access calculations and output personal finance data, financing options, insurance options and item comparatives related to the contemplated purchasing transaction. The mobile device 20 may also have a digital wallet or like electronic payment application, related to or independent from the account server 30, such as Apple® Pay, Google®, Paypal®.

The bank server systems may include the account server 30, an application server 40, and a login server 50, all of which servers 30, 40 and 50 may include a plurality of different servers, or by grouped as a single server system but are referred to server in the singular for simplicity, although multiple servers are likely involved. Likewise, the servers 30, 40 and/or 50 may be part of a cloud service, for instance a third-party cloud service for a bank.

Although the expression “bank” is used, the expression refers to financial institutions offering financial services. The servers 30, 40 and 50 may be operated by a single financial institution, or by various financial institutions and affiliates, including fintech entities, credit card companies, insurance companies or affiliates. A merchant server, point-of-sale terminal or system 60 may also be involved in the purchasing transaction. If insurance products are offered by the methods 100 and 200 described herein, an insurer server 70 may also be involved in the purchasing transaction.

The account server 30 (a.k.a., a transaction server) manages the source accounts and the savings accounts, and is conventionally highly secure, with limited access. In the embodiment of FIG. 1, the account server 30 has the account numbers, folio, balances, the card numbers and the passwords specific to the user A. The account server 30, while referred to in the singular, may be account servers of distinct entities, such as an account server 30 of a financial institution, and an account server 30 of a credit card company.

The application server 40 is the interface between the mobile device 20 and the account server 30. The application server 40 with or without the account server may be the payment processor system. The application server 40 will simplify the requirements to access the user accounts in the account server 30. The application server 40 manages and stores the user configuration as described hereinafter, and performs validation using data received as part of a user file, namely the question and personal answer, the user-selected image and/or phrase. The application server 40 also generates tokens. In an embodiment, an identifier token is generated for persistent storage in the mobile device 20. By persistent storage, the present disclosure refers to the fact that a same identifier token may be used for numerous sessions. In an embodiment, the identifier token is permanent. In another embodiment, the identifier token must be replaced after the expiry of an allotted time period (e.g., 90 days). It is considered to use a unique identifier as identifier token. Other temporary tokens may also generated (e.g. session tokens) used for a limited number of sessions (e.g., one session) by the mobile device 20, to change settings in the user configuration. For instance, if the application is closed, temporary tokens may be required to change settings. Likewise, if the allotted session time has expired (e.g., 5 minutes), the user is timed out, and a new temporary token may be required. According to an embodiment, the tokens carry no sensitive data, such as user identification, account numbers, passwords, etc. The tokens may be random in terms of information they contain, and are associated with an identity by the server systems.

The system servers may also feature the login server 50 by which the user A can create accounts to subsequently perform purchasing transactions in the manner described hereinafter. The login server 50 may require interventions from the financial institution to create accounts, or may be operated by personnel from the financial institution responding to a call from the user A. The login server 50 collects data of a user file, including identity of the user, question and personal answer, user-selected image/phrase, a password. The login server 50 shares the information to the account server 30 and the application server 40. It bears mentioning that the personnel may be involved strictly for the configuration or setting phase, and is no longer required after, notably because of the latency of and lag caused by human intervention in financial transactions. Moreover, the functionalities of the login server 50 may be integrated into the account server 30 and/or the application server 40. In an embodiment, the servers 30, 40 and 50 are operated by a single financial institution.

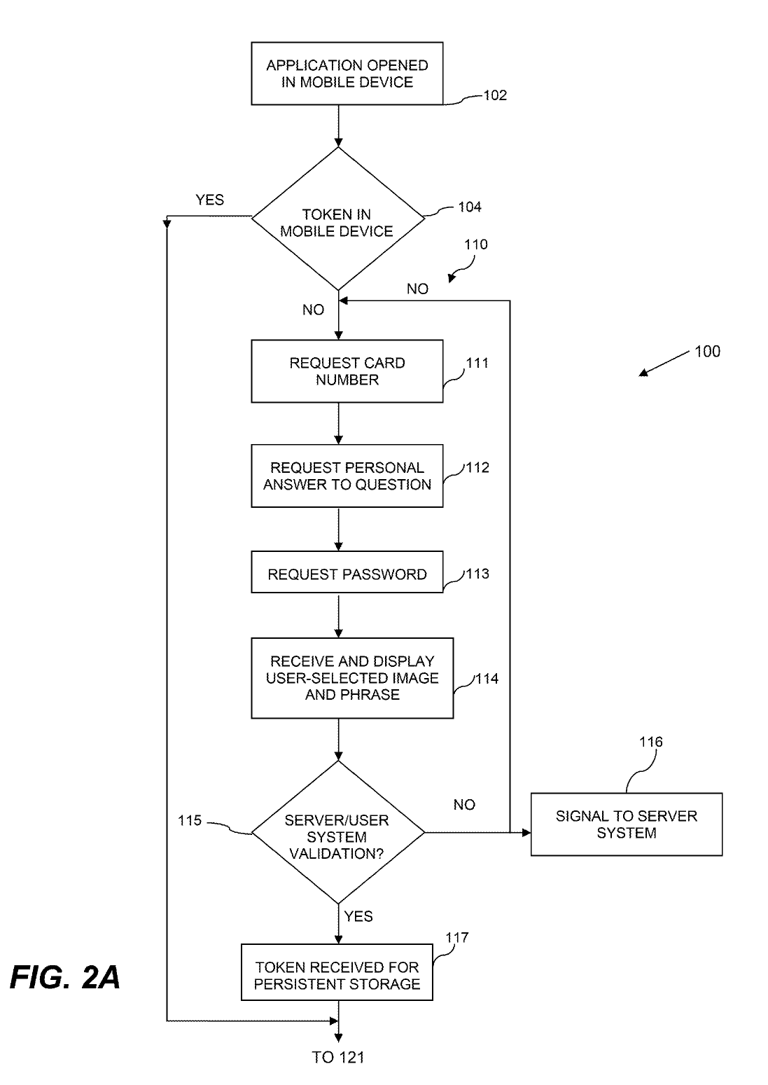

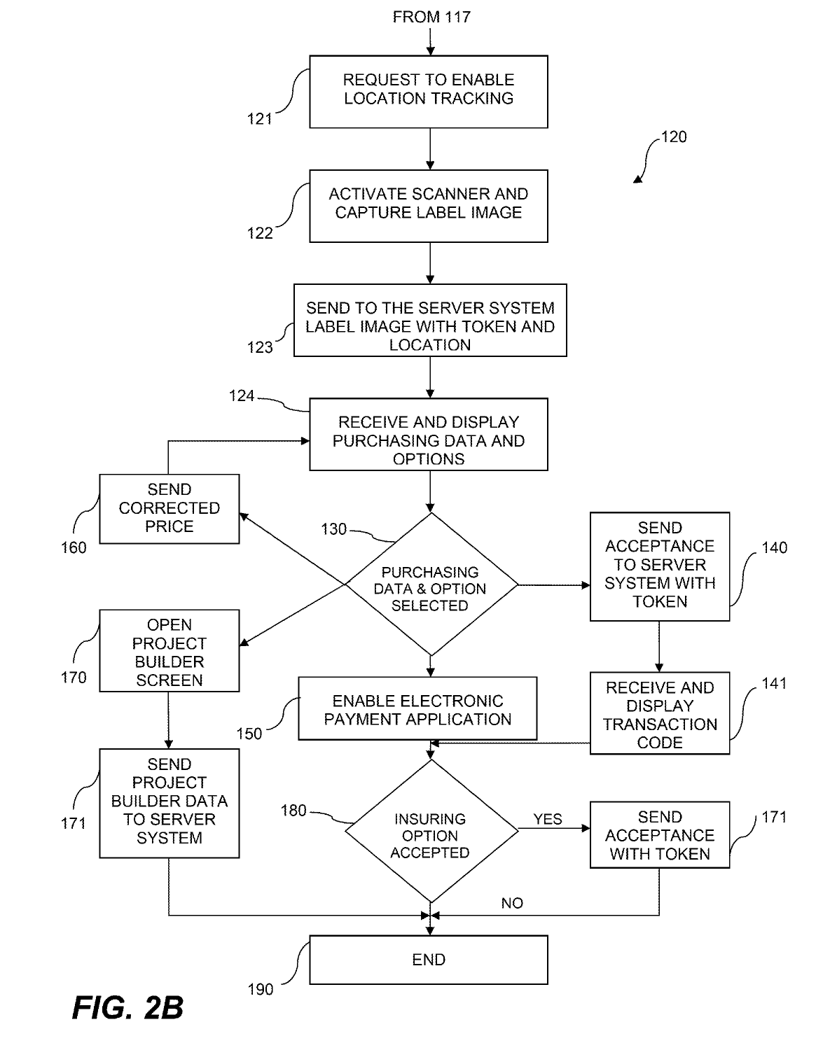

Referring concurrently to FIGS. 1 and 2A-2B, there is illustrated a method for assisting a user in purchasing items at 100. The method 100 is of the type that is performed by one or more processors of the mobile device 20 running the non web-based application in the arrangement of the system 10 of FIG. 1. For instance, the method 100 is executed by a computer program product, i.e., the application, stored in a non-transitory manner in the memory of the mobile device 20 in the form of computer executable instructions.

According to 102, the non-web based application is opened on the mobile device 20. At this point, the application has been downloaded and/or installed on the mobile device 20. The application may be a sub-application, tab or parallel application of another application or of a mother application already on the mobile device 20. Moreover, the web login has been performed or is performed to reach 102, for example through the mother application, whereby a user account exists in the account server 30, and a user file is saved as initial configuration is in the application server 40.

In being opened, the application will verify if a persistently-stored token is already in the mobile device, at 104. Assuming that it is user A's first login, the mobile device 20 must be initiated and configured for purchasing assistance. If the token is not in the mobile device at 104, the method 100 may follow the sequence of steps shown at 110, to login to the application server 40, which login steps may only be required for the initial login, and may not be required for the user A to perform purchases occurring later on, as will be described. The sequence of steps 110 may not be exhaustive, as other steps or substeps may be present.

According to 111, the card number or user identification is requested. Considering that the web login has been performed, a card number has already been granted or a user identification already exists, and the user A has already set a password for the card number or user identification in the login 50. The server system hence already has a record of the card number or user identification associated with the user file and user accounts. 111 may be performed only when the user configuration is created, with an option for the user A to have the mobile device 20 remember the card number or user identification for subsequent user modifications. In 111, as an alternative(s) to a card number, user A may enter an email address, user identification, and password, based on such data already being present in the login, registration or enrollment phase (e.g., via login server 50).

In 112, a personal answer may be requested to a question. This information, i.e., the question and personal answer, is obtained from the server system, based on the initial web login 50. In an embodiment, the personal answer and card number/user identification validation is done by the application server 40.

In 113, a password is requested for the card number and/or user identification, though this may be part of 111. The password of 113 is associated with the card number and/or user identification of 111. Accordingly, the server system may already validate the password associated with the card number. In an embodiment, the password and card number/user identification validation is done by the account server 30. Although the personal answer to question as per 112 is requested prior to the password as in step 113, to add another level of safety prior to allowing access to the configuration (especially of the card number/user identification is memorized by the device 20 after the creation of the user configuration), these steps may be switched such that the password is obtained prior to the personal answer to question.

According to 114, a user-selected image/phrase resulting from the web login may be received by the mobile device 20 from the server system and displayed. In an embodiment, the user-selected image/phrase is provided by the application server 40. This is an anti-phishing function that may be performed by the system 10, based on the cooperation from the user A. While 114 may feature both an image and a phrase, a single of these two options could be provided in 114. For instance, the phrase may be less demanding in terms of bandwidth.

The steps 111, 112, 113 and/or 114 of the sequence 110 may be performed in any appropriate order, jointly or separately. In an embodiment, a single application page may deal with the card number/user identification and password, while another application page may display the information based on the steps 113 and 114.

Accordingly, as identified in 115, the server system performs a validation when the user A logs in, the validation being accomplished on two different levels for example, namely the account server 30 and the application server 40. If, at the outset of 115, validation is not completed, the sequence 110 may be repeated, or an alert signal may be sent to the server system as shown at 116. For instance, if a given amount of attempts has been performed with the sequence 110, the signalling of 116 may be reached to alert bank authorities.

If the server system validates the information at 115, a token is received as shown at 117, for persistent storage in the mobile device 20. The identifier token may be provided by the application server 40, although it may be provided by other servers as well. The identifier token may be generated by the mobile device 20 and shared with the applications server 40 or other member of the server system.

In yet another embodiment, this login phase is performed via a mother application from the financial institution, with a token already persistently stored on the mobile device 20.

With the token persistently stored in the mobile device 20, the user A may use the application for purchasing assistance in the manner described below. When the user configuration has been completed according to the steps described above, and if the mobile device 20 comprises an identifier token, the sequence of steps shown at 120 may be performed, for purchasing assistance to be offered.

When user A requires purchasing assistance, the mobile device 20 may optionally automatically request the user A to enable the location tracking present in the mobile device 20, as per 121, as a response to 102. The location tracking may be in the form of the global positioning system (GPS) capability of the mobile device 20. As another possibility, the mobile device 20 may receive location data from the local network, or the user A may be prompted to enter the location. The application may also operate without the location, whereby the user A may simply refuse any request for location data to be rendered available in the method 100. The location services providing the location data may also be the default application setting in the mobile device 20 or the location services may be automatically turned on.

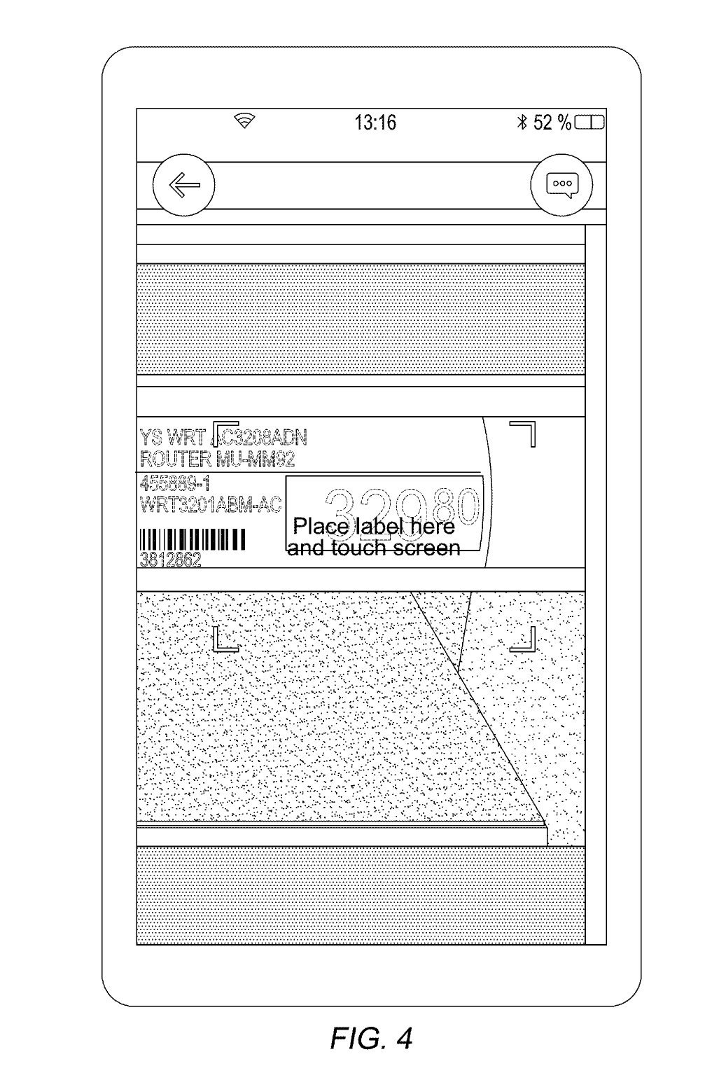

As per 122, the mobile device 20 may automatically open a scanner function as a response to a completion of 121, or as a response to 102 if the location tracking is already enabled, bypassed, or not offered as part of the method 100. The opening of the scanner function in 122 may also require a touch confirmation from the user A for the mobile device 20 to go in a capture mode, to avoid unnecessary use of the camera. The scanner function may use the camera function of the mobile device 20 to capture label images. For example, there is illustrated in FIG. 4 an image of a screen at the capture of the label image. The capture may be triggered manually by the user A taking a picture, or may be automatically triggered when the mobile device 20 has substantially immobilized. 122 may therefore operate with the movement tracking of the mobile device 20, i.e., the inertial sensors built into the mobile device 20. For instance, as shown in FIG. 4, the screen may have target markings to assist user A in positioning the label within the image.

According to 123, the label image obtained by the mobile device 20 in 122 is automatically sent to the server system, along with the identifier token, upon being captured. If location tracking has been enabled, the instant location data of the mobile device 20 may also be sent to the server system.

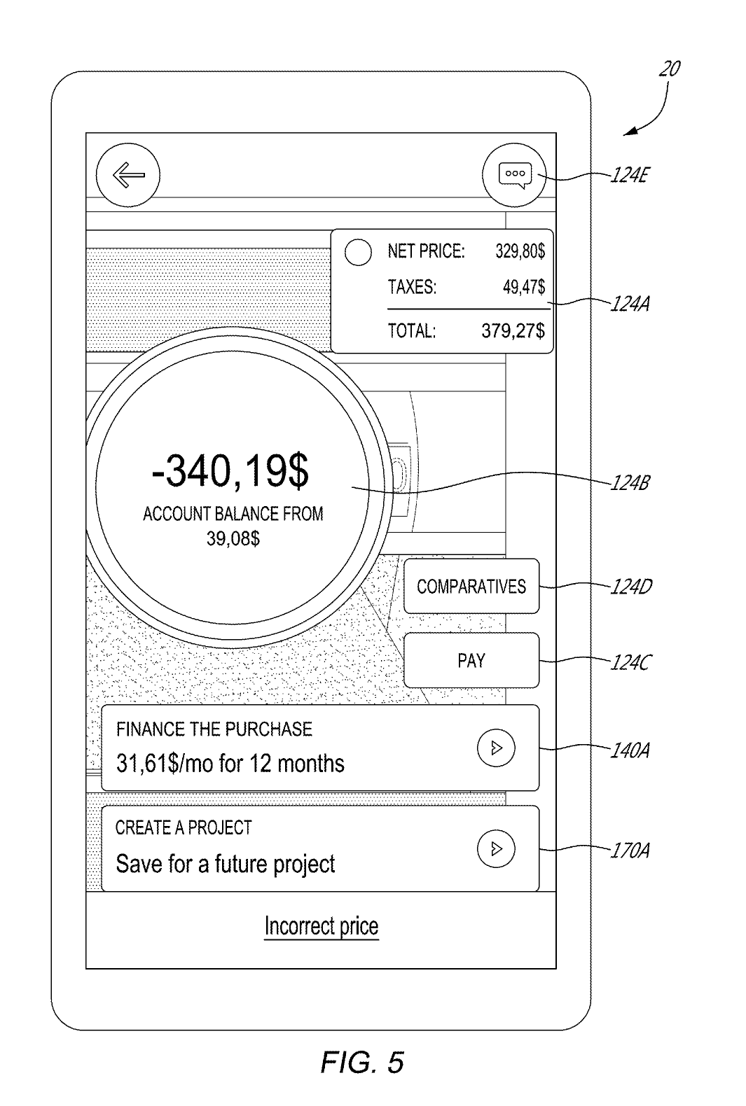

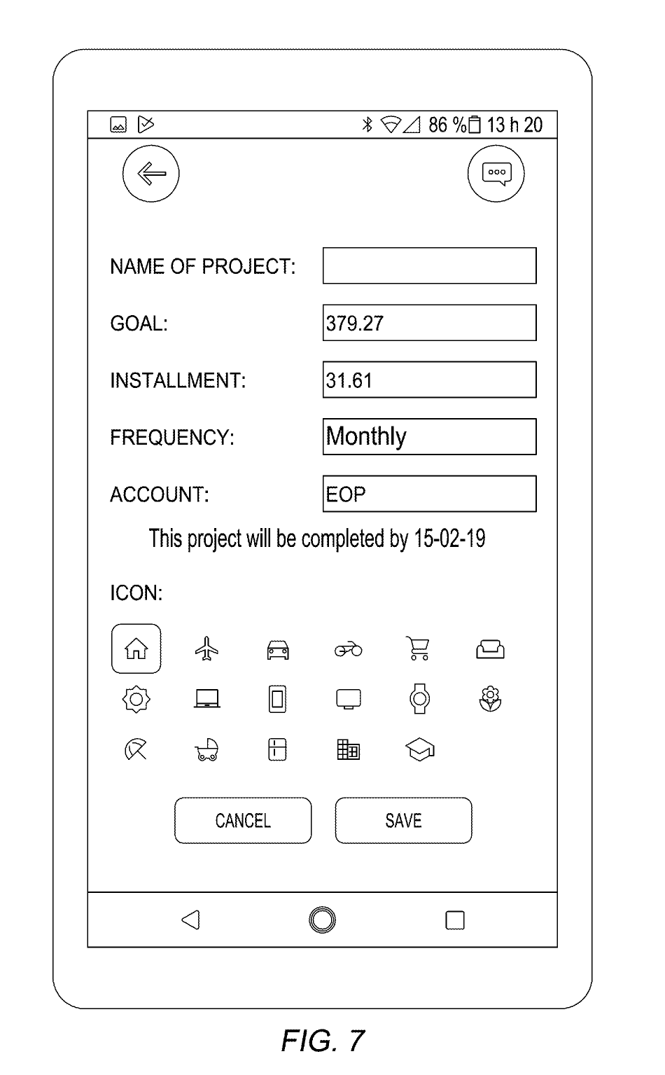

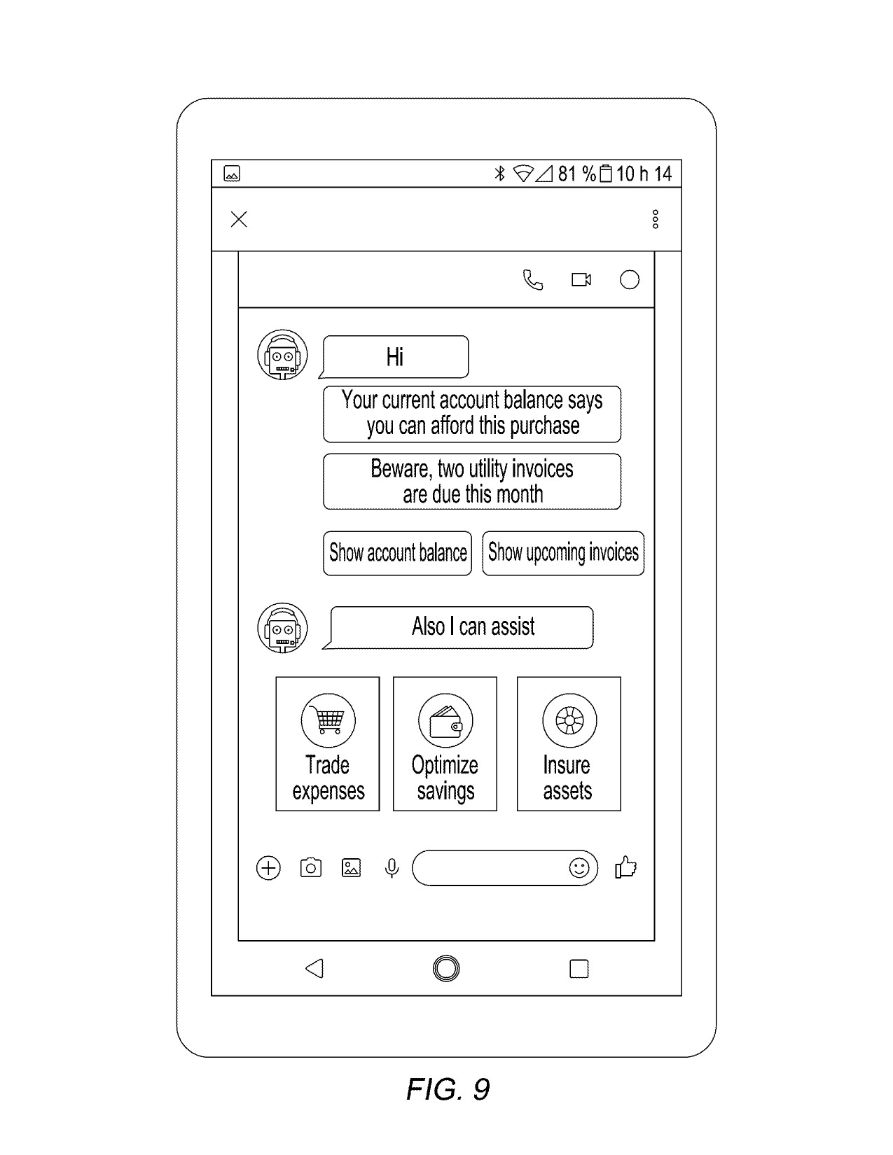

In response, at 124, the mobile device 20 automatically receives purchasing data and options from the server system. The mobile device 20 may display the purchasing data and/or options in the non web-based application. FIG. 5 shows an exemplary screen with the information. The screen of FIG. 5 is shown as being augmented reality with camera feed, though the screen may also have a non-photographic background, or may include parts of the captured label image, for instance with image processing (e.g., framing of label image, cropping of label image). Various windows and widgets may be present on the screen to display the purchasing data and/or the purchasing options. The calculations leading to the display of data may be performed by the server system and/or by the mobile device 20, using the data provided by the server system. The purchasing data and the purchasing options may include:
A pricing display 124A: the pricing display 124A may display the price of the item whose label has been imaged at 122. The price may include the applicable taxes, the price before taxes and/or the total. Additional information that may be provided include any applicable rebate, any mail-in rebate. The applicable taxes may be calculated as a function of the location of the mobile device 20, and may thus be based on the taxes applicable in the country, in the state, in the province, etc. The taxes may include any other governmental fee, such as duty (e.g., for tires), environmental handling fees, etc, applicable to the item under consideration. These taxes and fees may be separate entries. The location data may also result in obtaining the identification of the merchant, in which case some special rebates may apply as per promotions between the merchant and the financial institution offering the method 100. In such a scenario, the special rebates may be shown and the promotion may be displayed and explained.
An available funds display 124B: the available funds display 124B may inform the user of the impact of a purchase of the item under consideration on the accounts listed in the user profile. For example, the data may include the current balance of the account, and/or the anticipated balance after purchase. The data may simultaneously show multiple accounts for the user A, for instance if these accounts have been identified in the configuration phase described above. The available funds display 124B may also provide an indication or assessment of the user A's capacity to purchase the item based on account history. In such account history, the information that may assist the server system in determining the user A's capacity includes the dates of credits and of debits. The dates include weekly, fortnight, monthly, yearly, etc. For example, the credits may include pay cheques, compensation cheques, dividends, investment revenue and any other credit source. The debits may include credit card payments, rent, mortgage, investment contribution, insurance, municipal taxes, incoming tax. For example, in spite of not having the instant capacity to pay for the item in debit, the user A may afford the item A with a credit payment, for settlement in the current period. As part of the available funds display 124B, or at any other location on the screen, the mobile device 20 may offer the payment option 124C, for the mobile device 20 to activate an electronic payment application upon activation.
A comparable price display 124D: the server system may provide comparable price information for display by the mobile device 20. For example, the mobile device 20 may indicate the price of the same item identified by the label image of 122, at a nearby location using the location services. In such a case, the distance, direction and/or estimated time to destination may also be provided by the server system and displayed by the mobile device 20. The comparable price display 124D may also be for the same item or equivalent item within ordering range. For example, the comparable price display 124D may generate an estimated total of the item as purchased via electronic commerce. In the latter scenario, the estimated total may include shipping, customs, duty, applicable taxes, etc. The comparable price display 124D may only be available as per user A's preference, or may only be provided if favourable options are available to user A.
A financing display 140A: in some instances, the server system will determine that the user A cannot afford the item for cash payment, or may not be able to pay for the item without credit. Accordingly, the server system may provide one or more financing options to user A. One of the financing options may be through available capacity under user A's line of credit. The financing option with line of credit may include data such as a suggested payment schedule, estimated interests to be paid. As one other financing option, the server system may provide second credit limit financing for display by the mobile device 20. In second credit limit financing, the financial institution operating the method 100 may offer a payment schedule for a given term, with periodic installments (e.g., monthly).
A project builder display 170A: again, in some instances, the server system will determine that the user A cannot afford the item for cash payment, or may not be able to pay for the item without credit. The mobile device 20 may hence offer the project builder display 170A, by which the user A may be given a savings plan to set aside the funds to purchase the item at a later date, without incurring interest. The project builder display 170A may lead to a project builder screen as shown in FIG. 7, and described hereinafter.
Other displays may include a chat assistance icon 124E, by which a live operator may be available to answer questions, though the live operator may not be in a position to intervene in the purchasing assistance due to the quantity of information to be shared to the live operator, and the quantity of information to be gathered, which information can only be provided in real time or quasi-real time by the assistance of server processing speeds and network communication. Referring to FIG. 9, the chat assistance may lead to a chatbot screen, in which the indication or assessment of the user A's capacity to purchase the item based on account history is explained in a text-style message. The text-style screen with of FIG. 9 may offer an option of seeing upcoming debits and/or upcoming invoices, as obtained from the account history. Moreover, the text-style screen may link the user A to other options, such as expense tracking, savings optimizing and an insurance link.
An “Incorrect price?” link may also be available, which incorrect price link may lead to an entry field in which the correct price may be entered. The augmented reality set up described above may be useful to simultaneously display the image of the label and the pricing display 124A, and hence prompt an indication of incorrect price.
An insuring option may also be rendered available by the server system and received and displayed by the mobile device 20, as “insuring assets” for example. The insuring option may be available as part of the screen of FIG. 5, or at a later point in the purchasing or financing steps, or in the text-style screen on FIG. 9. The insuring option may include the insurance premium, the period of coverage, periodic installments. Different insurance packages may also be made available for display.
The information displayed may also include special advantages or privileges offered by the financial institution if the transaction were to be completed. For example, there may be displayed the privilege points resulting from the transaction. This type of information is well suited to be displayed as augmented reality items.

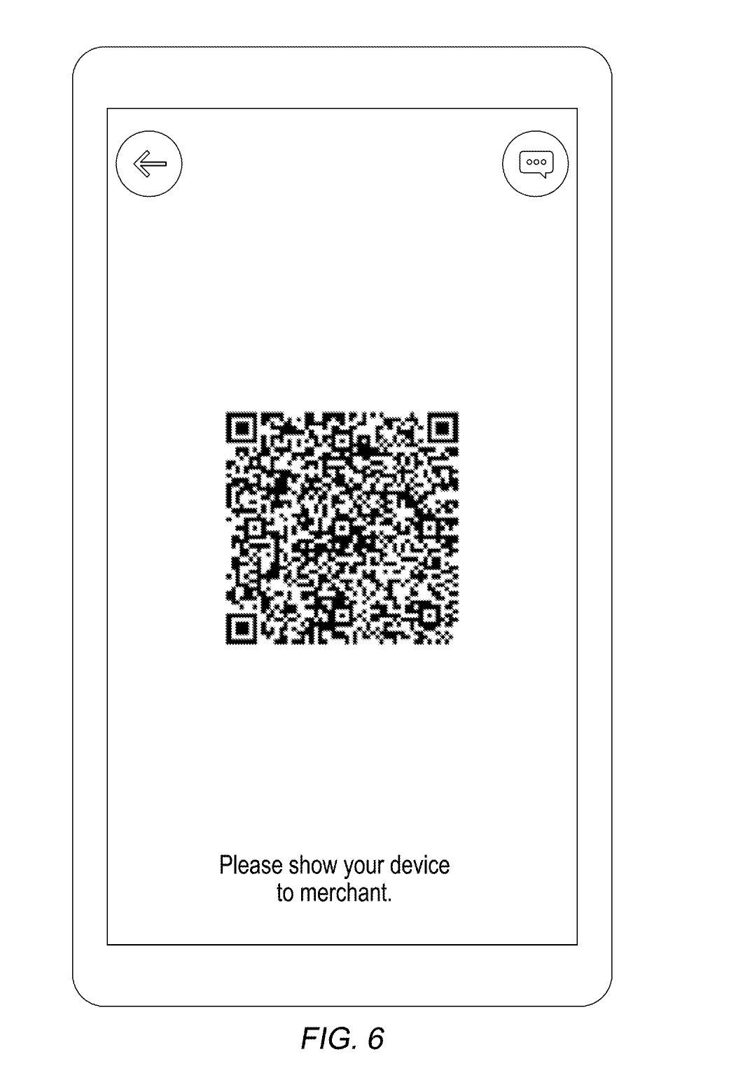

The various displays described above in the screen in FIG. 5 may be in separate windows as illustrated, or may also be in any other format. The various displays may lead to other screens, as those shown in FIGS. 6, 7 and 9, that may elaborate on the financial data and options.

Pursuant to the display of purchasing data and options by the mobile device 20 in 124, the user A may touch or activate any of the afore-mentioned purchasing data and option selections at 130. The activation of the various options may result in the communication of the appropriate data from the mobile device 20 to the server system. The identifier token may accompany the data for identification purposes.

As one option, the user A may select a financing option via the financing display 140A. As shown in FIG. 5, the financing display 140A may provide the terms. Selection of this option may cause the mobile device 20 to send financing acceptance to the server system at 140. According to an embodiment, by having the user A accept the terms of the financing option, the financial institution operating the method 100 becomes the creditor for the user A. The financial institution therefore must transact with the commerce and/or merchant selling the item to send the amount of funds required to complete the transaction, as detailed hereinafter. While such a transaction entails some form of agreement or contract between the parties, the server system may use the user profile data to populate the fields of the various forms necessary to proceed with the transaction, notably for the merchant to note purchaser details for insurance purposes. Hence, by the method 100 and use of the mobile device 20, this type of transaction is automated and accelerated for all parties involved. According to an embodiment, the financial institution is the creditor, the user A is the debtor or borrower. There may be no direct financial transaction between the user A and the merchant, no transfer of account data and/or card information via the merchant at the point of sale (POS) such as via a POS terminal, and/or no entry of a password associated to a credit card, debit card at the POS terminal of the merchant.

For the user A to complete the purchase at the POS, the mobile device 20 may receive and display a transaction code at 141. An example of a transaction code is shown in FIG. 6, as displayed on the screen of the mobile device 20, in the form of a QR code. Other transaction codes may include barcode and a near-field communication (NFC) signal, among other examples. The transaction code is consequently used by the user A at the POS terminal to conclude the purchasing transaction. According to an embodiment, the transaction code is a transient code, with a duration of minutes. According to an embodiment, the transaction code contains no account information for the user A, no personal information on the user A.

As another option, the mobile device 20 may activate an electronic payment application at 150, if the user A selects the electronic payment option, as in 124C. According to an embodiment, the electronic payment option is a third party payment service available in the mobile device 20. According to an embodiment, the electronic payment option is associated with a credit card of the user A. 150 may also include the payment directly from an account (e.g., debit, savings, line of credit, credit card, etc) at the financial institution. In such a scenario, a similar approach as 140 and 141 may be adopted, in such a way that the merchant's POS terminal is not used in the transaction. Instead, a transient random transaction code may be used to identify the transaction by the user A to the merchant, while the fund movements are between the user A and the financial institution, and between the financial institution or credit card issuer and the merchant.

As yet another option, in response to an “incorrect price?” selection, the mobile device 20 prompts the user A to enter the correct price, and sends at 160 the corrected price to the server system. As a result, the mobile device 20 may receive from the server system and display the updated purchasing data and options, based on the corrected price.

As yet another option, in response to the user A's selection of the project builder option via the project builder display 170A, the mobile device 20 opens a project builder screen as shown in FIG. 7. In the project builder screen, the user A may be asked to fill fields, including project name. The non-web application in the mobile device 20 may populate some fields including the goal, a periodic savings amount, a savings frequency, and an account identification. The goal may be a dollar value representative of the price of the item to purchase, as displayed previously in 124A. The periodic savings amount and savings frequency may be suggested by the non-web application based on an estimated savings capacity for the user A as calculated by the server system. Based on the data in the fields, the non-web application may display a tentative completion data for saving the sufficient funds to purchase the item. The user A may have the capacity to overwrite the recommendations, for instance to accelerate savings. As a consequence, the tentative completion data is adjusted as the data in the project builder screen of FIG. 7 are changed. This may for instance be done in real-time. The determination may be done by the mobile device 20.

Upon completion of the project builder task, the mobile device 20 may send the project builder data to the server system at 171, for an automatic implementation of savings for the user A. This may be in the form of automatic transfers of the amounted entered in the screen of FIG. 7, periodically. The mobile device 20 may eventually push special notifications upon reaching milestones or as motivational messages to encourage savings.

In some instances, the item may be of insurable nature. Accordingly, at 180, an insuring option may be offered, upon completion of the transaction. The insuring option may use the product identification to propose a complementary policy, for example. However, it is contemplated to also offer the insuring option at an earlier moment in the method 100, such as before payment. Upon selection of the insuring option, the acceptance is sent to the server system by the mobile device 20, with the identifier token. The server system may use the user profile data to populate the fields of the various forms or contract necessary to insure the item of the transaction.

The various options detailed above may lead to the end of the method at 190, which end may be in the form of a logout. A logout icon may be provided throughout the method 100 for the user A to stop the purchasing assistance at any point. It may be possible to offer as an option to activate the scanner, as in 122, to pursue the shopping assistance with the method 100. The sequence of steps of the method 100 may be repeated for subsequent purchasing assistance, for additional items.

It is considered to have numerous identifier tokens per mobile device 20, with each identifier token being associated with one user configuration. For example, the user A may create user configurations for different accounts. Upon reaching 140, 150 and/or 170, the user A may navigate between user configurations (e.g., using a side swap) to select a given account. Hence the server system would recognize the user configuration using the identifier token related to the user configuration.

It is hence observed that the method 100 describes steps executed by the mobile device 20 in collaboration with the server system, to assist the user A in purchasing an item or item(s) by turning on the non web-based application on his/her mobile device 20. The user A may also save various screens like the screen of FIG. 5, for later use. For example, the user A may use the mobile device 20 to gather information on a plurality of separate items by applying the method 100 until step 124 and prior to making a selection under 130, to plan at a later moment a purchase financing or project planning.

In an embodiment, the method 100 may be generally described as a method for assisting a purchase of an item with a mobile device such as the mobile device 20. The method 100 may include capturing, by the mobile device, a label image of an item. An identification associated with a user stored in the mobile device 20 may be sent, e.g., automatically from the capture, to a server system at least with the label image. The mobile device 20 may receive, from the server system, and display terms of a financing option specific to the user as a function of a price on the label image, along with an indication of an action to perform to finance a purchase of the item according to the terms of the financing option, as an automatic response to the sending of the identification. Other information may be received as well, such as price with tax, rebates, etc. The mobile device 10 may send to the server system a request for financing along with the identification in response to the action being performed. This method 100 may include other steps and/or sequences as described above. The steps may occur in real-time or quasi real-time, for example depending on the mobile device's processing speed, up to the point when the user A must provide an input.

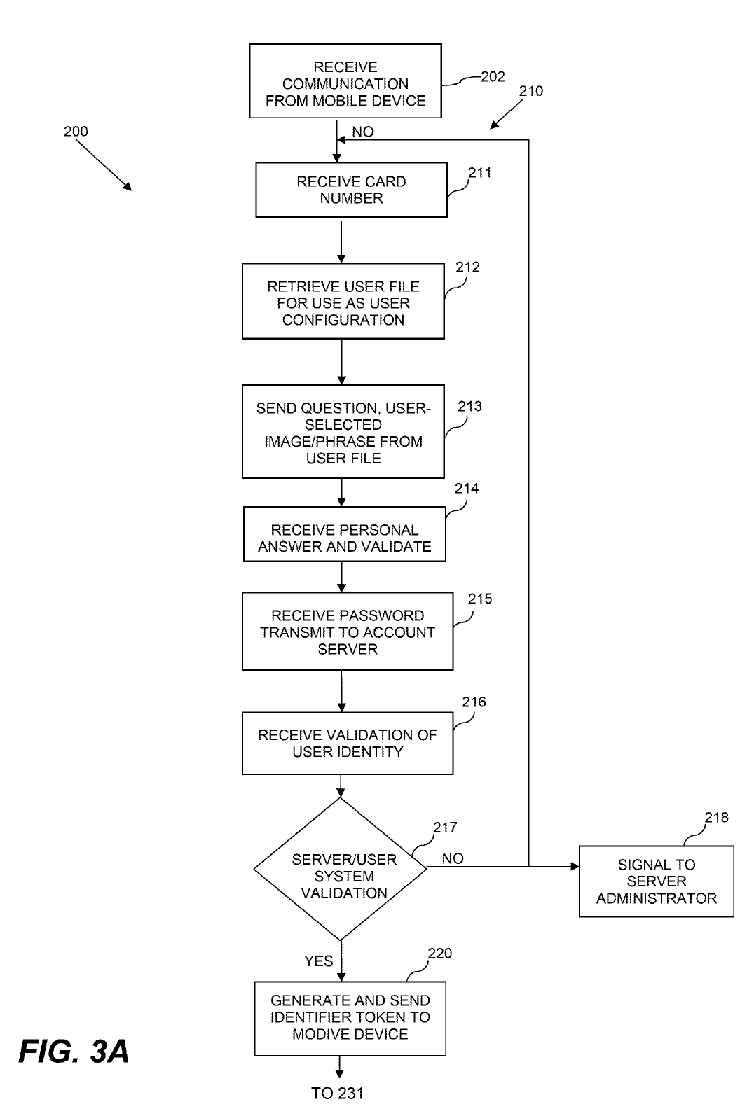

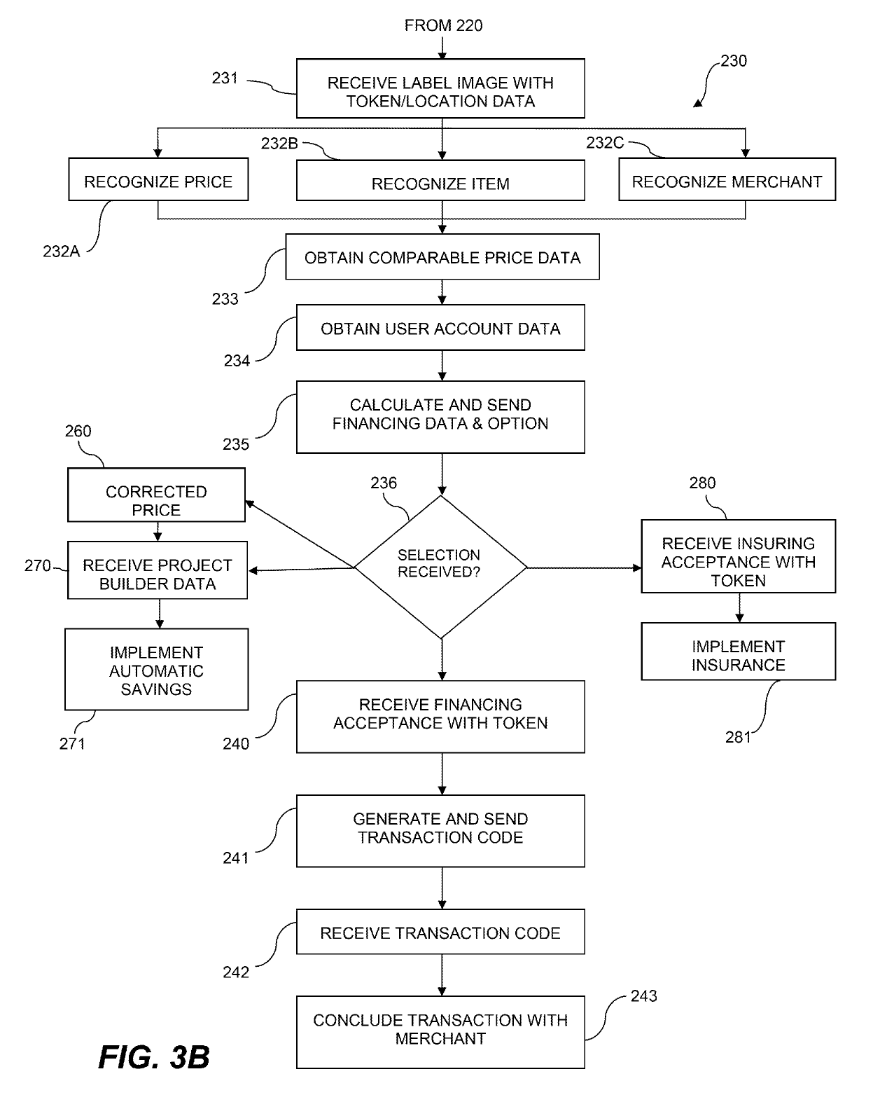

Referring concurrently to FIGS. 1 and 3A-3B, there is illustrated a method for assisting a user in purchasing items based on a request from a non-web based application of a mobile device at 200. The steps of the method 200 are performed by the server system, for example such as by the application server 40, interfacing the mobile device 20 with the account server 30, the merchant server 60 and/or the insurer server 70, for fund transfers to be executed in the account server 30. The application server 40 may include one or more processors to perform the method 200. By way of example, the method 200 is executed by a computer program product stored in a non-transitory manner in a memory of the server system, e.g., application server 40, in the form of computer executable instructions.

Prior to performing the method 200, the application server 40 receives a user file from the web login server 50, which user file contains information as described hereinafter for the method 200. Data from the user file is saved in the databases of the application server 40, as part of the user configuration.

According to 202, the application server 40 receives a communication from the mobile device 20. The communication from the mobile device 202 results from the opening of the non-web based application in the mobile device 20. This initial communication is related to a user's attempt to configure a non-web based application in the mobile device 20, for subsequent use in receiving purchasing assistance. The application server 40 receives this communication without the identifier token unique to the mobile device 20, and specifically related to the user A. Although not fully described, the communication received in 202 may be as a response to the user A's intention to change settings for the non-web based application.

As the communication from the mobile device in 202 is without the identifier token, the application server 40 may perform a sequence of steps 210 to validate the identity of the user, the order of which steps 210 may vary. In 211, the application server 40 receives a card number from the mobile device 20 and associates the card number to the user file.

The card number received at 211 is used to receive or retrieve a user file specific to the user at 212, which user file is stored in the database of the application server 40 as user configuration. The information stored in 212 is described above for FIG. 1.

As part of the user configuration, the application server 40 may retrieve a question and user-selected image/phrase from the user file/configuration, and send same to the mobile device 20, as in 213, for validation. 213 may be done after receiving a password associated with the card number.

In 214, the personal answer produced by the user on the mobile device 20 will be received and the personal answer may be validated with the personal answer in the user file/user configuration. On the other hand, the application server 40 will not receive an indication from the mobile device 20 that the user-selected image/phrase is correct or incorrect, as the user-selected image/phrase in an anti-phishing feature performed by the system.

In 215, the password associated with the card number may be received, and the card number and password are transmitted to the account server 30 for validation. Indeed, as described above for FIG. 1, the account server 30 may store the card numbers and passwords, and associates same to the accounts. 215 may occur at a later point. However, by having the password entered at 215, i.e., after 213 and/or 214, the user may benefit from an anti-phishing feature.

As per 216, as a result from the validation by the account server 30, the account server 30 authorizes access to data related to the source accounts and savings accounts. Hence, the application server 40 may receive a validation of the user identity, from the account server 30.

Accordingly, two levels of validation may be performed, as the validation is accomplished by the account server 30 which seeks another level of validation from the application server 40. The application server 40 will validate the personal answer to the question in steps 213 and 214, while the account server 30 will validate the user identity via the card number and password at 211 to 215.

At 217, if the two levels of validation are not completed, one or more steps 210 may be repeated, for instance to ensure that a user identity is validated with the correct password or that the correct personal answer to the question is received. A problem may be signalled at 218 to bank authorities if necessary, if the given number of attempts to login have failed.

If the two-level validation has been done at 217, an identifier token is sent by the application server 40 to the mobile device 20, at 220, for persistent storage in the mobile device 20. The application server 40 may generate an identifier token for the mobile device 20 at 220, if there is no identifier token present already, as per 204. As mentioned above, the mobile device 20 may already have an identifier token if the mobile device 20 has already been initiated and the user configuration is sufficiently complete.

Referring to FIG. 3B, a sequence of steps is illustrated at 230, and is performed by the application server 40 to assist a user in the purchase of an item. The method 200 may begin with step 231 if the mobile device 20 has been previously configured following the steps set out at 210.

At 231, the application server 40 obtains a label image captured by the mobile device 20, along with the identifier token. If location tracking has been enabled, the location data associated with the captured image may also be received by the application server 40, from the mobile device 20.

According to 232A, 232B, 232C, as an automatic response to the reception of the label image, the application server 40 may recognize different types of information from the captured label image, and location data if available. In 232A, 232B and/or 232C, the application server 40 may operate optical character recognition (OCR) to recognize the data, or may share the image data with a third party server offering OCR service. The application server 40 may also employ other ways to obtain the data, notably using bar codes, or by obtaining wireless signal from the merchant. Although the steps 232A, 232B and 232C are illustrated in parallel, the method 200 may include performing all steps or any combination of the steps 232A, 232B and 232C, in any particular order, or in a logical order described below, as part of the purchasing assistance of any given item.

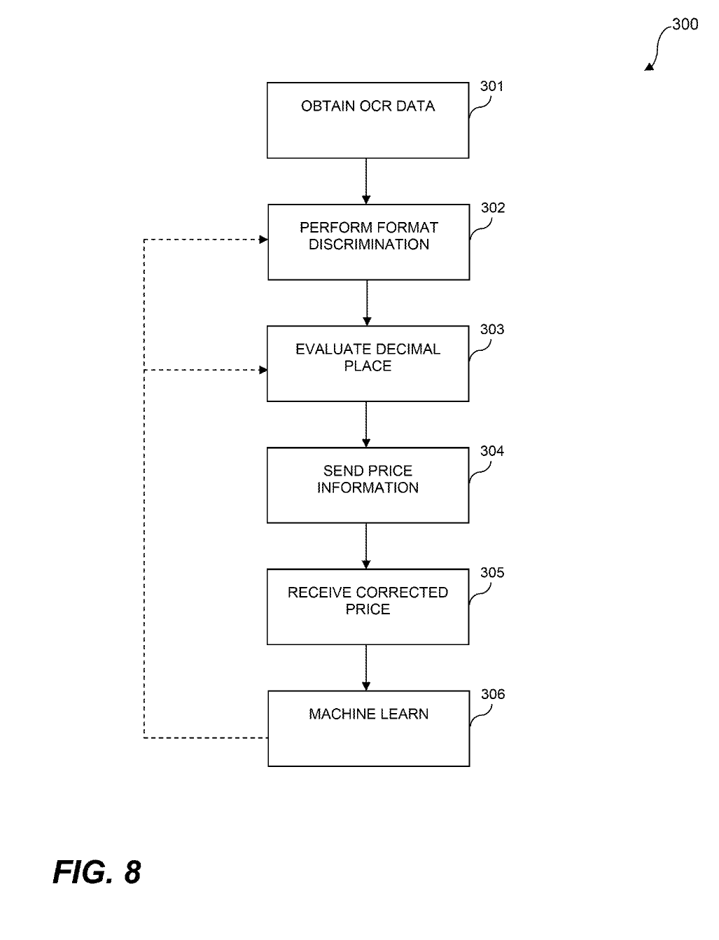

In 232A, the application server 40 recognizes the price from all available information in the captured label image. According to an embodiment, the various numbers of the label image are obtained using OCR or barcoding, and the application server 40 may determine the price. According to an embodiment, step 232A is performed by an algorithm that can determine the price from OCR in spite of the numerous data fields provided on the label. This is described in further detail hereinafter, with reference to FIG. 8.

In 232B, the application server 40 may recognize the item from the information of the captured label image. According to an embodiment, the application server 40 uses the barcode from the label (if present) to run the barcode against any database of barcodes. The applications server 40 may then communicate with merchant server 60 to obtain the relevant information on the item. In an embodiment, the item is identified by name or by an alphanumeric code, and such data may also be run against a database of product information, to identify the product.

The identification of the item in 232B may be assisted by an identification of the merchant, in 232C. The merchant may be identified by the application server 40 using the location services, i.e., the geographic location of the mobile device 20 when the image was captured, whether it be by GPS, cellular triangulation, manual entry, etc. Additional or alternative geographic location may also be obtained using the local Wi-Fi network, or user data entry to indicate the location of the mobile device 20 associated with the captured label image. Therefore, the identity of the merchant may be used in the identification of the item under consideration. For example, the application server 40 may consult the merchant server 60 to obtain the specifics of the item under consideration, including current price, and additional data, such as upcoming discount, inventory, etc. Moreover, the application server 40 may also use the location data to identify location-specific rebates that may apply as per promotions between the merchant and the financial institution operating the method 200.

The financial institution operating the method 200 may have pre-existing agreement with some merchants for financing terms, in which the financial institution may become the creditor for user A, while the merchant remains obligated to the user A for product warranty and servicing. As an example, the financial institution may have pre-existing agreements by which the financial institution obtains a discount on the item from the merchant, to use the discount as compensation for becoming creditor to the user. The pre-existing agreements may alternatively or additionally include a servicing fee, etc, or interest on the loan from the user A.

Pursuant to the steps 232A, 232B and 232C, the application server 40 has at least the price of the item, and an identity of user A via the identifier token. The application server 40 may also have an identification of the product, an identification of the merchant, a geographical location associated to the captured image and/or to the merchant, a current location of user A, among other data.

According to 233, the application server 40 optionally uses the location and product identity to obtain comparable price data. As mentioned previously for method 100, the comparable price data may be the price of the same item at a nearby location using the location services, with the distance, direction and/or estimated time to destination. The comparable price display may also include a price for the same item or equivalent item within ordering range, with an estimated total of the item as purchased via electronic commerce, with shipping, customs, duty, applicable taxes, etc.

According to 234, the application server 40 may automatically receive, from the account server 30, information regarding the accounts, such as the current and/or anticipated balance of accounts associated with the user A or with the identifier token, the credit/debit history of the accounts, the debt, a schedule of credits and of debits, such as for projected invoice dates, etc. The application server 40 may share the identifier token with the account server 30 as a security verification.

According to 235, the application server 40 may calculate and automatically send to the mobile device 20 financing data and options. Consequently, in response to reception of an identifier token and a captured label image by the mobile device 20, the application server 40 performs at least the steps 231, 232A, 234 and 235, and possibly any of the other steps. The financing data and options as determined, obtained and sent by the application server in 235 may include any of:
The price with the applicable taxes, the price before taxes and/or the total, any applicable rebate, location-specific rebates, merchant-financial institution promotions, any mail-in rebate, etc. The applicable taxes may be calculated as a function of the location of the mobile device 20, and thus based on the taxes applicable in the country, in the state, in the province, etc. The taxes may include any other governmental fee, such as duty (e.g., for tires), environmental handling fees, etc, applicable to the item under consideration;
Current balance of the account, and the anticipated balance after purchase. The data may simultaneously show multiple accounts for the user A, provided these accounts have been identified in the configuration phase described above;
An indication or assessment of the user A's capacity to purchase the item based on account history, with cash settlement or through a credit payment, for settlement in the current period;
Comparable price of the same item at the nearby location using the location services, as determined in 233, including other relevant information such as the distance, direction and/or estimated time to destination;
One or more financing options to user A through available capacity under user A's line of credit, second credit limit financing, for example with payment schedule for a given term, with periodic installments (e.g., monthly). In the case of second credit limit financing, the financial institution may have pre-existing agreements with the merchants, whereby the financing terms may be calculated and sent to the mobile device 20 as a function of the identity of the merchant.
Special advantages or privileges offered by the financial institution if the transaction were to be completed. For example, there may be displayed the privilege points that would result from the transaction.

The various steps grouped at 230 may be performed automatically by the application server 40 as an automated response to the reception of a captured label image and identity token from any mobile device 20 that is registered under the program of purchasing assistance. Therefore, the application server 40 is responsible for automatically sending to the mobile device 20 the purchasing data and options shown in FIG. 5 as exemplary screen with the information, as a response to receiving a captured label image with identifier token. As mentioned above, some of the information may be displayed after a further request, such as from the text-style screen of FIG. 9. As mentioned above, some of the financing data and options may be calculated by the mobile device 20.

The application server 40 may then act based on the various options given to the user A, and may receive a selection at 236. If no response is received after a given set time at 236, the method 200 may be timed out, and the user may be requested to recapture a label image to reactivate the method 200 at the series of step 230, or to resend an image previously captured and stored in the mobile device 20.

According to option 240 at the selection 236, the user A may select the financing option via the financing display 140A of FIG. 5. In such a scenario, the application server 40 may receive the financing acceptance with token at 240. If more than one financing option is provided, the financing acceptance may include the identification or the modalities of the selected financing option.

According to an embodiment, by having the user A accept the terms of the financing option, the financial institution operating the method 200 becomes the creditor for the user A. The financial institution therefore must transact with a participating merchant selling the item to send the amount of funds required to complete the transaction.

For the user A to complete the purchase at the point of sale (POS), the application server 40 may generate and send a transaction code at 241, such as the one shown in FIG. 6 as displayed on the screen of the mobile device 20, in the form of a QR code, barcode and a near-field communication (NFC) signal, among other examples. The transaction code may be issued specifically for the transaction for the item under consideration, at the outset of the calculations of 235, and may have a limited duration. Indeed, the transaction code may be of transient nature, with the application server 40 monitoring the duration of the transaction code. According to an embodiment, the transaction code is a random code that contains no user, account or transaction data. The transaction code is consequently used by the user A at the POS terminal of the participating merchant to conclude the purchasing transaction. The POS terminal may be equipped to capture the transaction code, and recognize it as being related to the financial institution operating the method 200, to transmit the transaction code to the application server 40. Accordingly, at 242, the application server 40 may receive the transaction code from the merchant server. The transaction code is the same or is reformatted while bearing the same identification capacity for the user A to be identified via the POS terminal, and hence for the application server 40 to conclude the transaction.

As a consequence, the application server 40 may conclude the purchasing transaction for the item by the user A, with the merchant having sent to the application server 40 the transaction code received by the mobile device 20 at 242, or a confirmation of correspondence of transaction code, if the verification is performed at the POS. As such a transaction may entail identifying the user A to the merchant, for instance for sale warranty and servicing, the application server 40 may use the user profile data to populate the fields of the various forms necessary to conclude the transaction, and to write up the contract to become creditor to the user A. Moreover, as the transaction is between the user A and the financial institution, and between the financial institution and the merchant, the user A does not have to go through a financing approval with the merchant. As such financing approval may require a contract and a file opening at the merchant, the cancellation of such step simplifies and accelerates the financing acceptance from the moment the user A decides to purchase the item. Moreover, the financing approval is performed without a third party involvement, such that the financial data may not be disclosed. In 243, the second credit limit financing may cause the purchasing transaction to be concluded by any combination of the following actions:
the various forms identifying the user A are sent to the merchant by the application server, although this may only be optional,
the application server 40 sends a request for acceptance of a contract to the mobile device 20 and then receives an acceptance of the contract with identifier token,
the application server 40 instructs the account server 30 to send the necessary funds to the merchant, and/or
the application server 40 is debited the item value with the merchant, for later settlement by the financial institution.

These steps may occur automatically through the procedural flow of steps described above.

By operating the second credit line financing option as described above, the financial institution may be the intermediary between the merchant and the user. Therefore, there is no fund transfer from the mobile device 20 at the POS terminal. Among other advantages, this limits or avoids the transfer of sensitive data, and the possibility of fraud. Moreover, the presence of the identifier token in 240 and of the unique transaction code or signal 241 provides two levels of identification in the purchasing transaction. The credit approval is not done through the merchant, it is direct between the financial institution and the user A.

According to another embodiment, the financing option involves the line of credit of user A. The application server 40 may instruct the account server to debit an amount to a line of credit accounted associated with the user A.

As another of the possible selections, in 260, a corrected price is received by the application server 40. The corrected price may be sent to 232A for a recalculation of the financial data and options. In an embodiment, the corrected price may be used for machine learning in the manner shown in FIG. 8. The corrected price may consequently cause the automatic performing of steps 233, 234 and/or 235 by the application server 40, for the mobile device 20 to receive refreshed financing data and options based on the corrected price.

As response to another option given to the user A, in 270, the application server 40 receives the project builder data. As part of the financing data and options, the application server 40 may have provided the necessary data for the mobile device 20 to fill out some of the fields of the project builder screen shown in FIG. 7. As an alternative, the selection of project builder display 170A with identifier token by the user A on the mobile device 20 may drive the application server 40 to seek the information to populate the fields of the project builder screen shown in FIG. 7, for instance by obtaining the information from the account server 30, or by using the data previously obtained as part of 234.

In receiving the project builder data from the mobile device 20 at 270, the application server 40 may instruct at 271 the account server 30 to create an account or an account folder or folio. In an embodiment, at 271 automatic fund transfers based on the specifics of the project builder data may be implemented as well. The project builder data may include one or more of the goal, the periodic savings amount, the savings frequency, and the account identification, as set out in FIG. 7.

As response to yet another option given to user A, in 280, the application server 40 may receive an insuring acceptance with the identifier token. While 280 is shown as a selection from the options at 236, the option of insuring may be received at a later point, notably after the purchase by the user A using an electronic payment with the mobile device 20, or during or after the conclusion of the financing and purchase set out in steps 240-243.

The application server 40 may have communicated with an insurer server 70 to obtain specifics of an insurance package or packages as a function of an identity of the item under consideration, and this may have been provided as part of the financing data and options sent for display by the application server 40 at 235. It is also contemplated to have the application server 40 communicate with the insurer server at 281, to obtain the insurance package(s). Accordingly, the application server 40 may send the user profile and related data to the insurer server 70, as well as other relevant information, such as item being considered, value, etc. The insurance forms may be filled out automatically by the application server 40. As another possibility, the identification of the item purchased and price, as obtained by the application server 40, may be sent to an insurance profile database at the insurer server 70, for eventual claims. The identification of the item purchased and price may for instance be stored as an asset of the user. Moreover, the identification of the item to be purchased may be used to obtain product warranty, for the insurance product proposed to be complementary to the product warranty.

Further purchase assistance may be performed for items different than the ones involved in the previous transfers. Otherwise, the transaction ends at any one of 243, 271 and 281.

Referring to FIG. 8, there is illustrated at 300 a method for recognizing a price. The method 300 may be a part of the method 200 for assisting a purchasing transaction based on a request from a non web-based application of the mobile device 20. For example, the method 300 may be executed as part of 232A by the application server 40.

According to 301, the OCR data is obtained by the application server 40. As mentioned previously, the OCR may be performed by the application server 40 as well, or may be imparted to a third party server offering OCR service. The OCR data may include may various entries, including price, rebates, price before and after rebate, product identification by name and by code, SKU, etc.

In 302, the application server 40 performs a format discrimination step to identify the price among the multitude of data entries. In doing so, the application server 40 may have a list of priorities to achieve the format discrimination. The priorities may be in the following order or in any other order:
Symbol and letter discrimination: any data entry including letters or given symbols, such as % or minus, may be discarded from the price identification.
Size: weight may be given in the discrimination to the size of the data entries, with the price usually in a bigger font.
Position: weight may also be given in the discrimination to the position of the data entries. For example, an end entry near the margins, or in the right-hand lower corner of the label, may be an indication of the price.
Format: weight can be given to the use of bold, underlining, italic or any given color.

Other factors may influence or may apply to the step of performing discrimination at 302.

In 303, an evaluation of the decimal place is performed by the application server 40. In some instances, the application server 40 may not the presence of a comma or period. The application server 40 may also note a font size variation in a single data entry, indicating the decimal. Without such visual cues, the application server 40 may divide the price entry by 100, of the amount of the price entry is greater than 100.

As a consequence, the price is determined by the application server 40 and may eventually be sent to the mobile device 20. In 304, the application server 40 may send or share the price information to/with the other steps of the method 200, or make it available for being sent at part of step 235 (FIG. 3B).

It may be possible that the price was not correctly identified by the method 300, whereby the user may enter the correct price. In such a case, the application server 40 may receive the corrected price at 305. This may include the method 300 using a product identification and location of mobile device 20 at image captured to identify the merchant, and to look up current price, and thus receive a corrected price, without the user's input. A machine learning step may then be performed by the method 300, to adjust the weight given by the factors provided above. According to 306, the application server 40 machine learns why the label was misinterpreted and may adjust the weight of the factors as a consequence. The application server 40 may consequently adjusts the steps 302 and 303.

In steps 124 and 235 described above, among others, concepts of personal finance may be applied to determine the user's capacity to purchase with or without financing. The criteria may vary according to financial institution, and may include among other things one or more of savings, debt, liquidity, cash flow history (debits, credits), credit score, spending tendencies, salary, compensation, bonuses, time of year (e.g., tax season), interest rates. As a financial institution may have access to most if not all of this data, the user's capacity can be performed in real-time or quasi-real-time, and may be automated. For example, some of the steps leading to the financing options may be performed in an automated sequence from the capture of the image. The set-up phase in which an identifier token is generated may occur at a delay from the purchasing assistance. For example, the delay may be quantified in hours, days, weeks and/or months, and the application and/or mobile device 20 may be turned off between the set-up and the purchasing assistance. At the end steps, a confirmation of transaction may be sent by the server systems to the mobile device 20 and/or to the merchant.

In an embodiment, the method 200 may generally be described as a method for assisting a purchase of an item by a server system based on a request. The method 200 may include receiving at least an identification, e.g., identifier token, associated to a user A and a label image of an item from the mobile device, such as the mobile device 20. The server system in the method may automatically obtain and/or determine and/or verify a price of the item from the label image. The server system may also obtain or retrieve a balance of at least one account of the user associated to identification. The server system may also determine terms of a financing option related to the price of the item, specifically for the user and as a function of the personal finances of the user. The server system may automatically send to the mobile device 20 the terms of the financing option, for display. The server system may then receive a request for financing along with the identification in response to an action being performed at the mobile device 20. The server system may then implement a transaction with the financing option according to said terms. This method 200 may include other steps and/or sequences as described above. The steps may occur in real-time or quasi real-time, for example depending on the mobile device's processing speed, up to the point when the user A must provide an input.

The above description is meant to be exemplary only, and one skilled in the art will recognize that changes may be made to the embodiments described without departing from the scope of the invention disclosed. For example, it is understood that the methods 100, 200 and 300 may apply to the purchasing of a service, and not only the purchasing of objects or tangible items. In fact, the expression item includes objects and services. Still other modifications which fall within the scope of the present invention will be apparent to those skilled in the art, in light of a review of this disclosure, and such modifications are intended to fall within the appended claims.

1. A method for assisting a purchase of an item with a mobile device, the method comprising:
capturing, by the mobile device, a label image of an item,
sending an identification associated with a user stored in the mobile device to a server system at least with the label image,
receiving, by the mobile device and from the server system, and displaying terms of a financing option specific to the user as a function of a price on the label image, along with an indication of an action to perform to finance a purchase of the item according to the terms of the financing option, as an automatic response to the sending of the identification, and
sending to the server system a request for financing along with the identification in response to the action being performed.

2. The method according to claim 1, wherein the identification is an identifier token, and further comprising, receiving from the server system the identifier token in the mobile device and persistently storing the identifier token at the mobile device, in a set-up phase.

3. The method according to claim 1, wherein receiving, by the mobile device and from the server system, and displaying includes receiving and displaying a current balance and/or a projected balance after a purchase of the item, for the at least one account associated to the user.

4. The method according to claim 1, wherein receiving, by the mobile device and from the server system, and displaying includes receiving and displaying at least a price of the item with applicable taxes and/or rebates.

5. The method according to claim 1, wherein sending the identification associated with the user at least with the label image includes sending data related to a location of the mobile device when capturing the label image.

6. The method according to claim 5, wherein receiving, by the mobile device and from the server system, and displaying includes receiving and displaying an identity of the item, and a price of a same or similar item at another merchant.

7. The method according to claim 6, wherein receiving and displaying an identity of the item, and a price of a same or similar item at another merchant includes receiving and displaying location data for the other merchant.

8. The method according to claim 1, wherein receiving, by the mobile device and from the server system, and displaying includes receiving and displaying an identity of the item, and a price of a same or similar item at another merchant.

9. The method according to claim 1, wherein receiving, by the mobile device and from the server system, and displaying include receiving and displaying the terms of the financing option include receiving installment data and period data.

10. The method according to claim 1, further comprising receiving a code for display on the mobile device for conclusion of purchase for the item according to the financing option, the code for use at a point of sale terminal of the merchant.

11. The method according to claim 10, wherein receiving the code for display on the mobile device includes receiving a code containing no information on an account and/or password of account.

12. The method according to claim 1, wherein the method is performed between the mobile device of a debtor and the server system of a creditor.

13. A computer program product comprising a computer readable memory storing computer executable instruction thereon that when executed by a computer perform the method steps of claim 12.

14. A method for assisting a purchase of an item by a server system based on a request, the method comprising:
receiving at least an identification associated to a user and a label image of an item from the mobile device,
automatically obtaining or determining a price of the item from the label image,
obtaining a balance of at least one account of the user associated to identification,
determining terms of a financing option related to the price of the item, specifically for the user,
automatically sending to the mobile device the terms of the financing option, for display,
receiving a request for financing along with the identification in response to an action being performed at the mobile device, and
implementing a transaction with the financing option according to said terms.

15. The method according to claim 14, wherein the identification is an identifier token, and further comprising, sending the identifier token to the mobile device for persistent storage, in a set-up phase.

16. The method according to claim 14, wherein automatically sending to the mobile device the terms of the financing option, for display includes automatically sending a current balance and/or a projected balance after a purchase of the item, for the at least one account associated to the user.

17. The method according to claim 14, wherein automatically sending to the mobile device the terms of the financing option, for display includes sending at least a price of the item with applicable taxes and/or rebates.

18. The method according to claim 14, wherein receiving the identification associated with the user at least with the label image includes receiving data related to a location of the mobile device at a capture of the label image.

19. The method according to claim 14, further comprising obtaining a price of a same or similar item at another merchant, and wherein automatically sending to the mobile device the terms of the financing option, for display includes sending the price of the same or similar item at another merchant.

20. The method according to claim 14, wherein determining terms of a financing option related to the price of the item, specifically for the user includes determining installment data and period data.
